(19) United States
(12) Patent Application Publication
(10) Pub. No.: US 2009/0242614 A1
(43) Pub. Date: Oct. 1, 2009

(54) METHOD AND TOOL FOR REPOSITIONING SOLDER FILL HEAD

(75) Inventors: GLEN N. BIGGS, WAPPINGERS FALLS, NY (US); RUSSELL A. BUDD, NORTH SALEM, NY (US); JOHN J. GARANT, POUGHKEEPSIE, NY (US); PETER A. GRUBER, MOHEGAN LAKE, NY (US); BOUWE W. LEENSTRA, WALDEN, NY (US); PHILLIP W. PALMATIER, HOPEWELL JUNCTION, NY (US); CHRISTOPHER L. TESSLER, POUGHQUAG, NY (US); THOMAS WEISS, POUGHKEEPSIE, NY (US)

Correspondence Address: GREENBLUM & BERNSTEIN, P.L.C., 1950 ROLAND CLARKE PLACE, RESTON, VA, 20191, US

(73) Assignee: INTERNATIONAL BUSINESS MACHINES CORPORATION, ARMONK, NY (US)

(21) Appl. No.: 12/056,573

(22) Filed: Mar. 27, 2008

(51) Int. Cl. B23K 1/20; B23K 3/06

(52) U.S. Cl. 228/176; 228/33

(57) ABSTRACT

A tool and method is provided for repositioning a solder injection head. The tool includes a first moveable platform positioned on a first side of a workpiece chuck and a second moveable platform positioned on a second side of the workpiece chuck. A solder injection head has a seal configured to seal molten solder within the solder injection head when contacting a surface of the first moveable platform or the second moveable platform. The method includes moving a workpiece chuck and a starting platform to a position such that the starting platform is at a finishing position and a finishing platform is in a starting position.

### FIELD OF THE INVENTION

The present invention generally relates to a tool used in the fabrication of semiconductor devices and methods of use and, more specifically, to a tool used to reposition a solder injection head and methods of use.

### BACKGROUND OF THE INVENTION

Controlled Collapse Chip Connection New Process (C4NP) represents a breakthrough in wafer solder bump technology, a semiconductor packaging technique which places pre-patterned solder balls onto the surface of a chip. These bumps ultimately carry data from individual chips to the rest of a computing system via a complex arrangement of intricate wiring and materials. C4NP is built around International Business Machines Corp.'s development of injection-molded solder.

In C4NP, molten solder is injected into cavities in a mold which are designed to match the wafer pads. C4NP allows the creation of pre-patterned solder balls to be completed while a wafer is still in the front-end of a manufacturing facility, The separate operations, e.g., bump formation and wafer processing, provides many advantages. For example, the formation of the solder bumps in the mold reduces the handling of fully processed wafers. This increases wafer yield as there is less likelihood of wafer damage or breakage. The separate processes also isolate the wafers from the yield losses due to failures in on-wafer bump formation. Also, the wafers and bumps can be processed in parallel, compared to serially, which effectively shortens line throughput time. Said otherwise, bump molding can be completed while the wafers are still in process potentially reducing cycle time significantly. Also, amongst other advantages, final assembly yield increases because bumps are inspected prior to transfer onto to the wafer. In this way, the bumps can be reworked as needed.

C4NP also easily accommodates binary, ternary and quaternary alloys and minimizes the recurring and additive costs of consumables since only the solder balls are created and transferred to the wafer without waste. The solder can also come in any form such as, wires or pellets, which are less expensive than plating solutions, preforms, or pastes. C4NP is also not dependent on wafer size, allowing 200 mm and 300 mm wafers to be processed with similar efficiency.

In current processing techniques, the method of injecting the solder allows travel of the mold relative to the injection head in a single direction. In order to cyclically process molds in current tools, there is a requirement to reposition the head from an end of process (finish) position to a beginning of process (start) position. This means having to process, e.g., fill, molds in a serial, batch process, as the injection head remains stationary.

Accordingly, there exists a need in the art to overcome the deficiencies and limitations described hereinabove.

### SUMMARY OF THE INVENTION

In a first aspect of the invention, a tool comprises a first moveable platform positioned on a first side of a workpiece chuck and a second moveable platform positioned on a second side of the workpiece chuck. A solder injection head has a seal configured to seal molten solder within the solder injection head when contacting a surface of the first moveable platform or the second moveable platform.

In an additional aspect of the invention, a tool comprises a workpiece chuck moveable in a horizontal direction and stationary in a vertical direction. A first moveable platform is positioned on a first side of the workpiece chuck and is independently moveable in the horizontal direction and the vertical direction. A second moveable platform is positioned on a second side of the workpiece chuck and is independently moveable in the horizontal direction and the vertical direction. A solder injection head has a seal configured to seal molten solder within the solder injection head when contacting a surface of either the first moveable platform or the second moveable platform. The solder injection head is configured to move in the vertical direction when positioned on one of the first moveable platform and the second moveable platform and remain stationary in the horizontal direction.

In a further aspect of the invention, a method of injecting solder into molds comprises moving a workpiece chuck and a starting platform to a position such that the starting platform is at a finishing position and a finishing platform is in a starting position.

### BRIEF DESCRIPTION OF THE DRAWINGS

The present invention is described in the detailed description which follows, in reference to the noted plurality of drawings by way of non-limiting examples of exemplary embodiments of the present invention.

FIG. 1 shows a tool structured and configured to reposition a solder injection head in accordance with the invention; and

FIGS. 2a-2p show operational stages of the tool shown in FIG. 1 in accordance with the invention.

### DETAILED DESCRIPTION OF THE INVENTION

The present invention generally relates to a tool used in the fabrication of semiconductor devices and methods of use and, more specifically, to a tool used to reposition a solder injection head and methods of use. By implementing the invention, it is possible to provide many advantages over known tools. For example, the present invention ensures that a proper seal is always maintained between a solder injection head and an underlying surface, thereby ensuring that the solder can be maintained in a molten state and remains within the solder injection head when not in use. Also, in implementation, the tool of the present invention eliminates the need for batch processing of the molds; instead, due to the flexibility of the tool it is now possible to process molds individually as needed. Additionally, as the solder injection head is always injecting solder in a single direction during mold fill, a consistent and constant load is always placed on the solder injection head (as the leading and trailing edges are always the same for each mold). This constant load, in turn, leads to predictability when filling the cavities of the solder mold, as well as ensures prevention of solder leakage. Also, as the leading and trailing edge always remain the same throughout mold fills, there is no oxide build-up on the leading edge which, in turn, provides a better quality solder.

In embodiments, the tool includes two lifting assemblies or “parking spaces” that are used in conjunction with the solder injection head to ensure a proper seal. The proper seal, in turn, prevents leakage and exposure to air thus reducing oxide build-up. The design of the parking spaces is such that they can be lifted in concert with the solder injection head to continue the leak and exposure prevention while allowing motion of the workpiece relative to these spaces.

### Tool in Accordance with Embodiments of the Invention

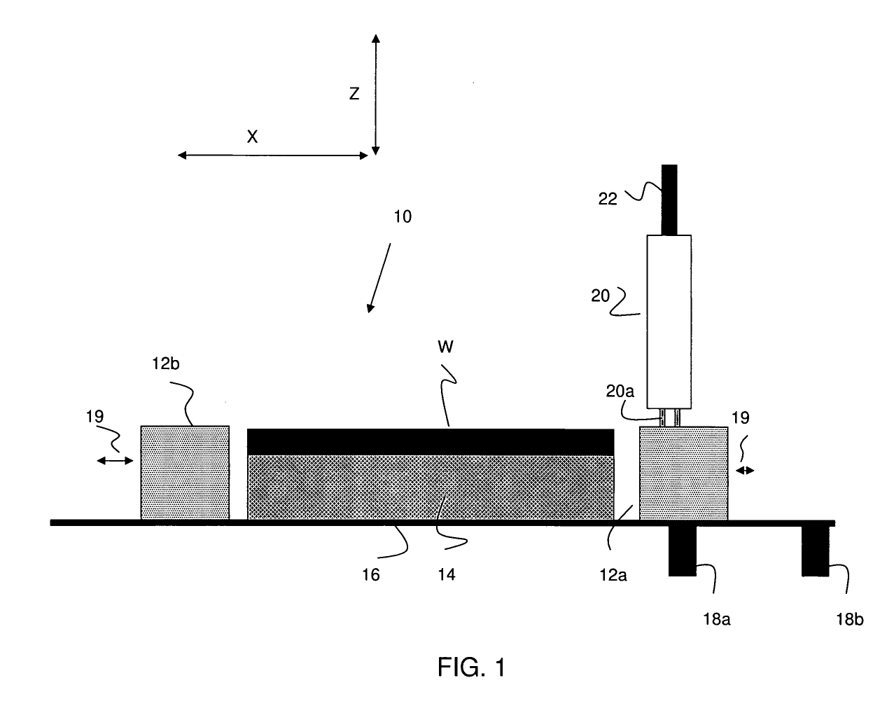

FIG. 1 shows a tool structured and configured to reposition a solder injection head in accordance with the invention. More specifically, the tool of the present invention is generally shown at reference numeral 10 and includes two moveable platforms (“parking spaces”) 12a, 12b, positioned on opposing sides of a workpiece chuck 14. The moveable platforms 12a, 12b and the workpiece chuck 14 are mounted to a moveable carriage having a rail and bearing system, generally depicted as reference numeral 16. In embodiments, the moveable platforms 12a, 12b can be raised or lowered in the z direction using conventional air cylinders 18a and 18b, or other known mechanisms (e.g., actuators). In embodiments, the lifting mechanisms are provided to lift and lower the moveable platforms 12a, 12b when they are at different locations in the x direction. Also, the moveable platforms 12a, 12b can be independently moved in the x direction using conventional mechanisms 19, e.g., linear actuators, air cylinders, etc.

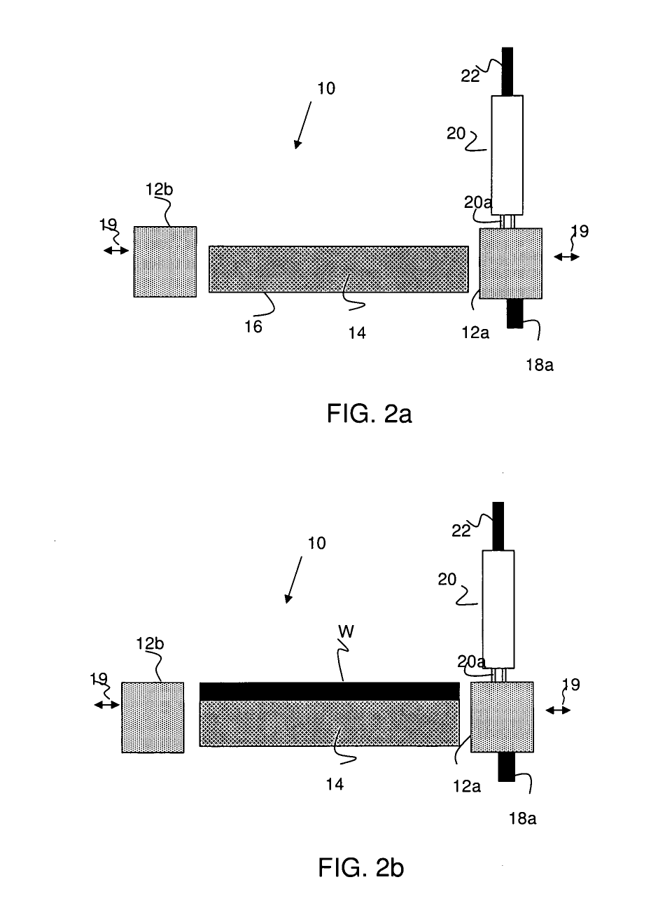

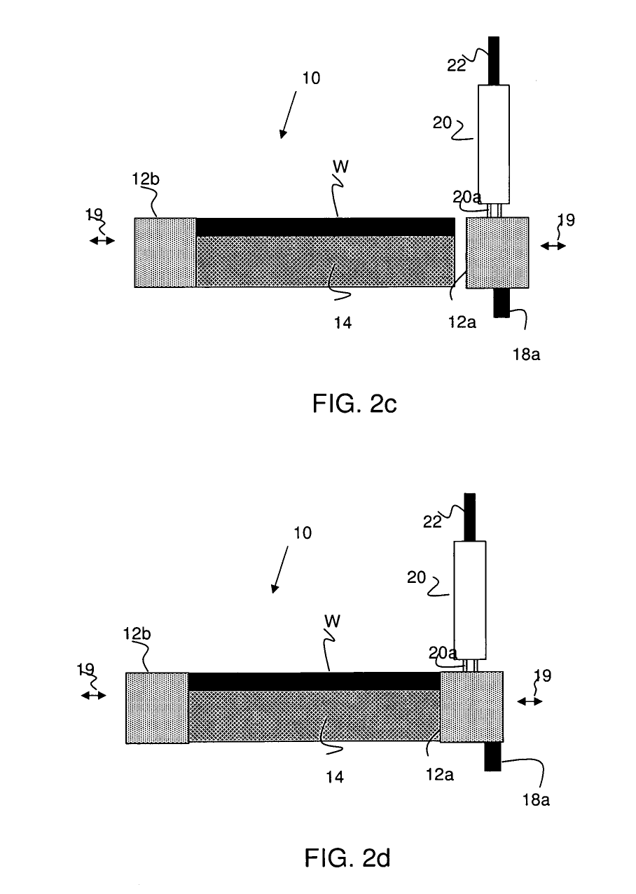

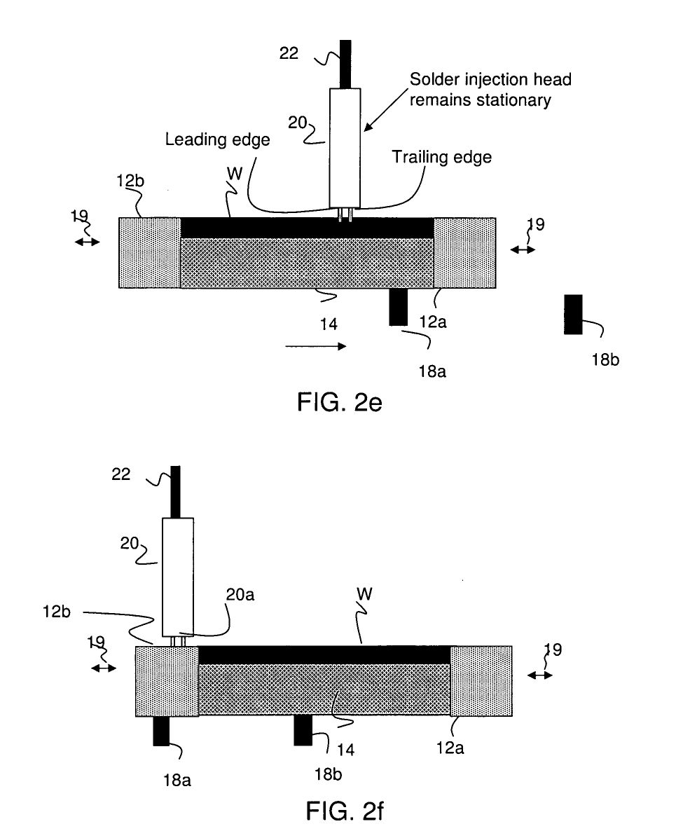

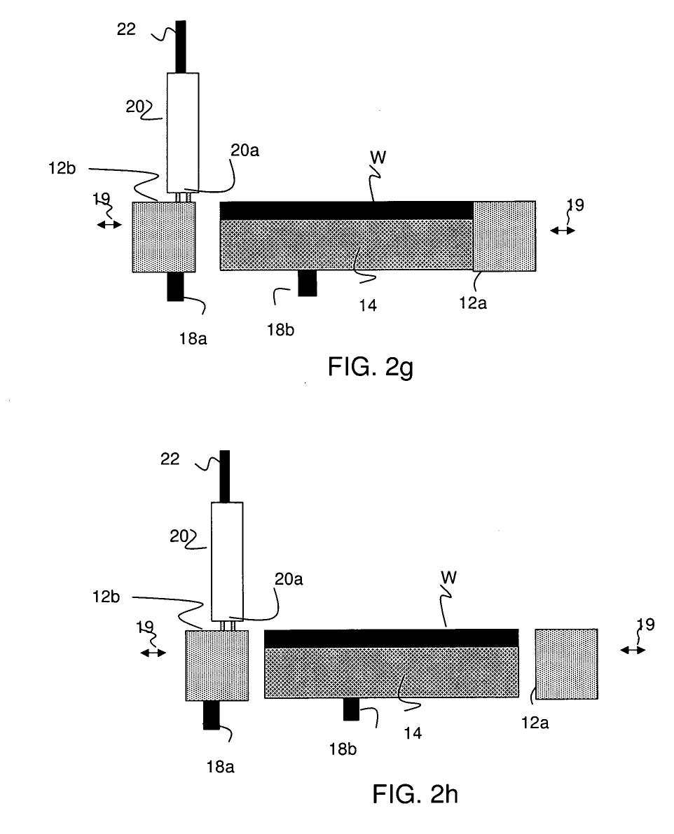

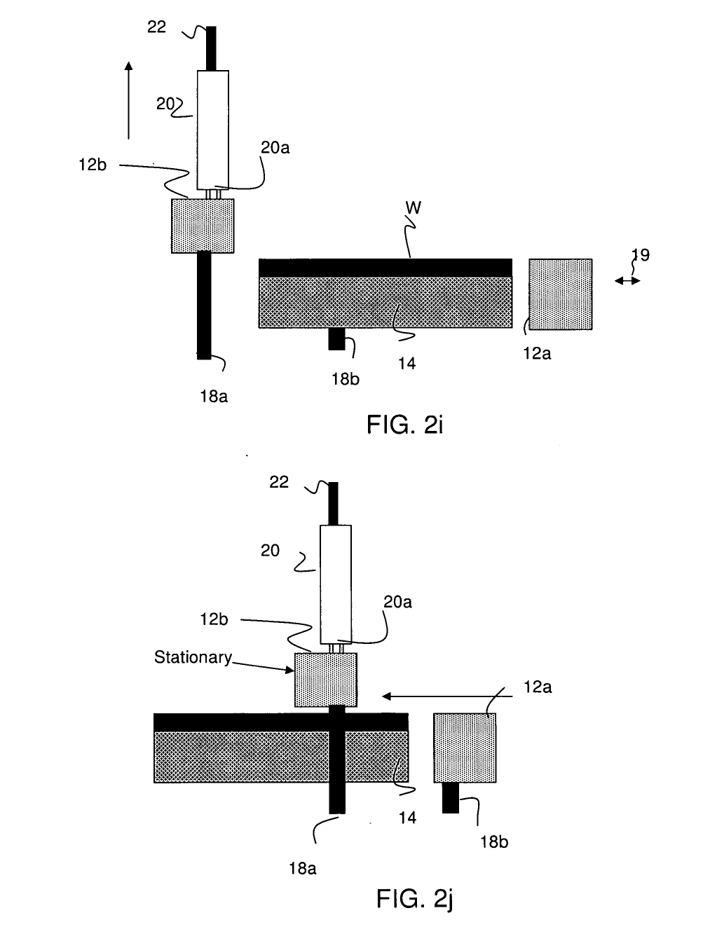

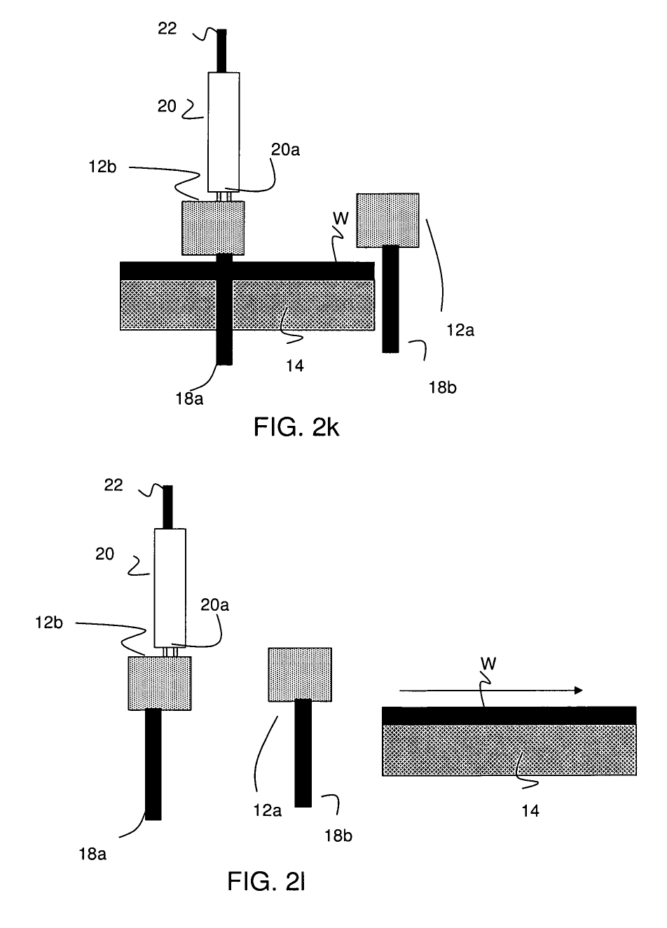

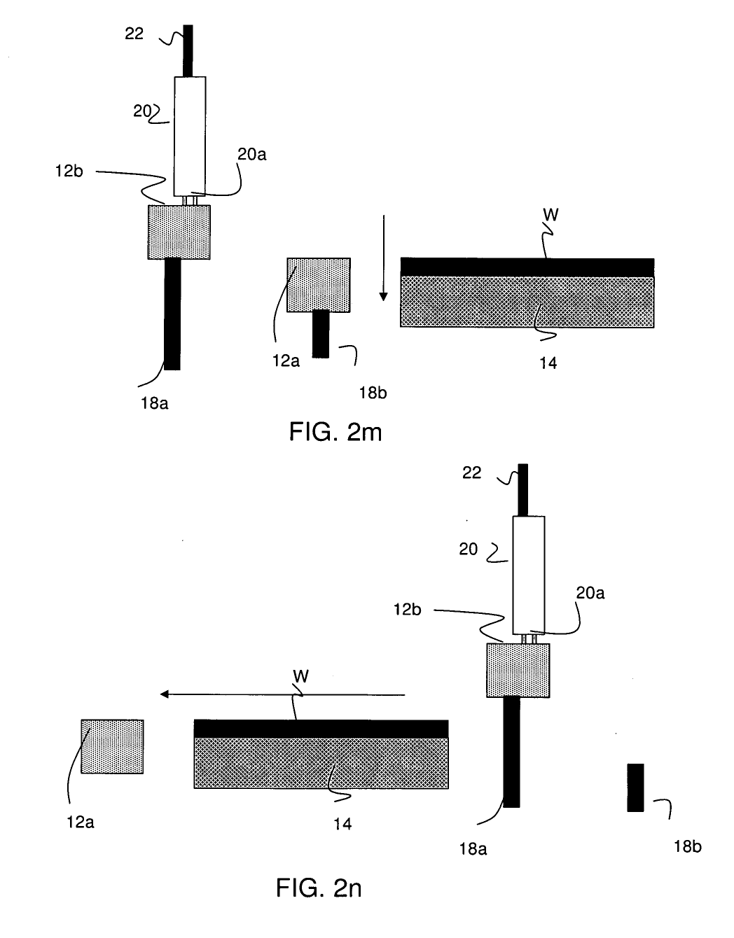

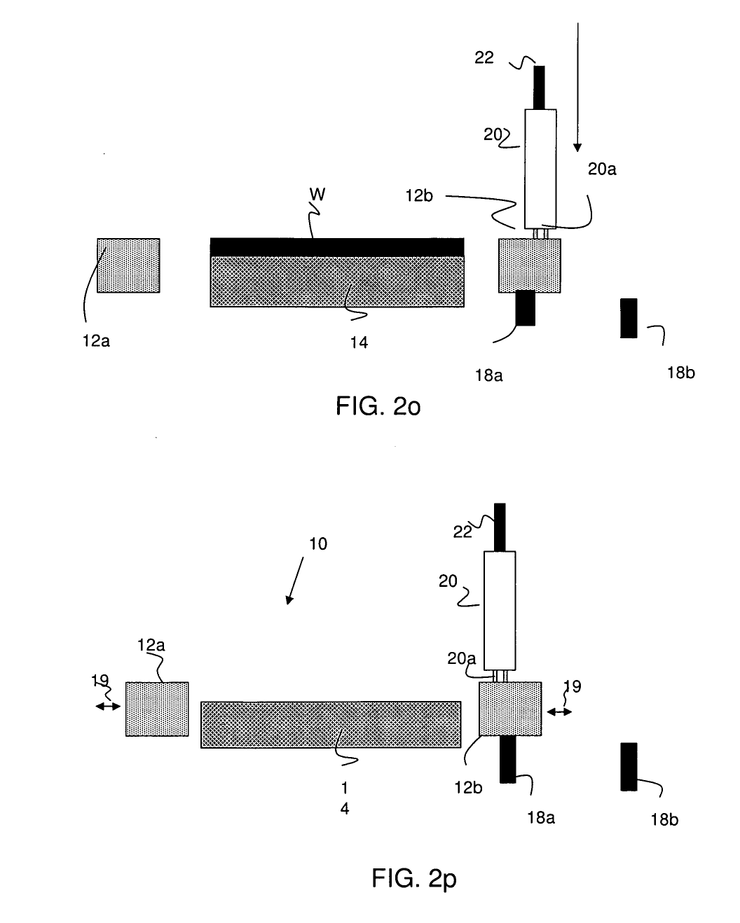

As shown in FIG. 1, a solder injection head 20 is positioned on the moveable platform 12a; however, it is understood that the solder injection head 20 can be positioned on the moveable platform 12a, over the workpiece chuck 14 or on moveable platform 12b (See, FIGS. 2a-2p). The solder injection head 20 includes a seal 20a, e.g., o-ring, that contacts the upper surface of the moveable platforms 12a, 12b and a workpiece, W, positioned on the workpiece chuck 14. (Those of skill should understand that the workpiece is a mold with a plurality of cavities for solder fill.) The seal 20a prevents leakage of solder from the solder injection head 20 when it is positioned on the surface of the moveable platforms 12a, 12b.

An air cylinder 22 or other mechanism (e.g., a spring) is positioned above the solder injection head 20, at an opposing side to the seal 20a. The mechanism 22 is configured to provide a regulated downward force on the solder injection head 20. This ensures an adequate (i.e., leak proof) seal between the seal 20a and a surface of the moveable platforms 12a, 12b or the workpiece, W. In one embodiment, the force is about 100 lbs; however, it should be recognized that any appropriate force to ensure an adequate seal is contemplated by the invention. Considerations to take into account when engineering the force include, for example, the viscosity of the solder, the type of material used for the seal, how large is the seal or solder injection head, etc.

As noted above, the moveable platforms 12a, 12b can be raised or lowered in the z direction using conventional air cylinders 18a and 18b or other known mechanisms. In embodiments, the moveable platforms 12a, 12b can be raised or lowered in the z direction when in certain x positions, e.g., aligned with one of the air cylinders 18a and 18b. In embodiments, the moveable platforms 12a, 12b are configured to be raised to a height above the workpiece, e.g., one or more inches. This ensures that the workpiece does not interfere with the movement of the moveable platforms in the x direction.

In operation, the moveable platforms 12a, 12b can move independent of each other as well as independent of the solder injection head 20. Also, the moveable platforms 12a, 12b can move independent or concurrently with the workpiece chuck 14. In preferred embodiments, the moveable platforms 12a, 12b can be raised or lowered when underneath the solder injection head 20. However, it should be understood that the moveable platforms 12a, 12b can be moved independent of the solder injection head 20 (when it is in its lifting position that is not under the solder injection head 20).

The workpiece chuck 14 is fixed in the z direction and can be moved left or right in the x direction via a carriage on the rail and bearing system or other conventional system generally depicted as reference numeral 16. Likewise, the moveable platforms 12a, 12b are also moveable in the x direction via the carriage 16. In one embodiment, the moveable platforms 12a, 12b are held onto bases, via a vacuum system, which is mounted on carriage 16. The air cylinders 18a and 18b are configured to lift the moveable platforms 12a, 12b from their base.

In embodiments, the solder injection head 20 is fixed in the x direction, and can be raised or lowered in the z direction via the moveable platforms 12a, 12b. In an alternative embodiment, the solder injection head 20 can also be moved in the x direction, depending on a particular application. As discussed in further detail below, when the solder injection head 20 is raised or lowered, the seal 20a remains in contact with either surface of the moveable platforms 12a, 12b, thereby preventing any leakage of solder. Also, the sealing of the solder within the solder injection head will allow the solder to remain in a molten state during transportation and when not in use.

FIGS. 2a-2p show operational stages of the tool of FIG. 1 in accordance with the invention. For ease of illustration, the carriage 16 shown in FIG. 1 is removed in order to more clearly show the different operational stages of the invention. However, it should be recognized by those of skill in the art that the workpiece chuck 14 and the moveable platforms 12a, 12b can be concurrently moved in the x direction via the carriage 16 during solder flow processes and the “swap” of platforms, as discussed in greater detail below. Also, one or more of the lifting mechanisms 18a and 18b may be removed in some of the illustrations to more clearly show operational stages which do not require the mechanisms 18a and 18b.

FIG. 2a shows a starting position of the tool 10. In this position, the solder injection head 20 is positioned on the moveable platform 12a with a force such that the seal 20a prevents leakage of the solder. The moveable platform 12a and the moveable platform 12b are positioned away form the workpiece chuck 14. This allows a wafer to be placed on the workpiece chuck 14 without any interference. At this operational stage, the workpiece is not placed on the workpiece chuck 14. The moveable platform 12a may be in alignment with the lifting mechanism 18a but this is not yet a requirement.

In FIG. 2b, the workpiece, W, is loaded on the workpiece chuck 14 in a conventional manner. In FIG. 2c, the moveable platform 12b is moved independently of the workpiece chuck 14 in the x direction by an actuator 19, toward the workpiece W. The moveable platform 12b will stop when it is in contact with the workpiece W. This contact can be detected by, for example, any conventional type sensor, e.g., physical contact sensor, or by a known distance of travel.

In FIG. 2d, the workpiece chuck 14 and the moveable platform 12b are moved together toward the solder injection head 20 and moveable platform 12a, while the solder injection head 20 remains stationary and the moveable platform 12a (start parking space) is held in place by friction with the seal 20a. This motion is continued until after contact is made between the workpiece and the moveable platform 12a, at which point the friction between the seal 20a and the surface of the moveable platform 12a is overcome. The movement of the workpiece chuck 14 and the moveable platform 12b is provided by the carriage (not shown).

FIG. 2e shows the workpiece, W moved under the solder injection head 20. More specifically, in FIG. 2e, the workpiece chuck 14, workpiece and the moveable platforms 12a, 12b are moved concurrently in the x direction (towards the right) by the carriage, while the solder injection head 20 remains stationary. In this manner, solder can be injected into cavities of the workpiece W. Also, as the relative movement of the solder injection head 20 is always in a single direction during mold fill, the leading edge and trailing edge always remain constant throughout mold fills. This ensures a constant, predictable load on the seal, as well as eliminates oxide build-up on the leading edge of the solder injection head 20. For illustrative purposes, lifting mechanisms 18a and 18b are shown to illustrate a relative movement of the assembly with respect to the lifting mechanisms 18a and 18b.

As shown in FIG. 2f, the movement of the assembly stops when the solder injection head 20 rests on the moveable platform 12b (finish parking space). As should be understood by those of skill in the art, a constant force remains on the solder injection head 20 (during the entire process) to ensure that the seal is properly sealed against a surface of the moveable platform 12b thereby preventing leakage of the solder. In this position, the moveable platform 12b is also aligned or substantially aligned with the mechanism 18a (which was originally near the moveable platform 12a prior to solder injection, e.g., movement of the assembly).

In FIG. 2g, the moveable platform 12b (finish parking space) is separated from the workpiece, W. In this position, the moveable platform 12b is aligned with the lifting mechanism 18a. The friction from the seal 20a holds the moveable platform 12 to the solder injection head 20 as the moveable platform 12a is moved in the x direction, away from the workpiece chuck 14.

In FIG. 2h, the moveable platform 12a is moved away (separated) from the workpiece, W, by the actuator 19. This provides clearance between the moveable platforms 12a, 12b and the workpiece, W, so that the workpiece can be removed.

In FIG. 2i, the moveable platform 12b and the solder injection head 20 are lifted, e.g., by the air cylinder 18a, so that the bottom of the moveable platform 12b is above a top plane of the workpiece, W. In FIG. 2j, the workpiece chuck 14 and the workpiece, W, as well as the moveable platform 12a are moved together under the moveable platform 12b and solder injection head 20 to an x location, e.g., moved until the moveable platform 12a is aligned with another air cylinder 18b (or other type of lifting mechanism such as, for example, an actuator). The movement of these components can be accomplished by the carriage (not shown in order to simplify the illustration of FIG. 2j). In FIG. 2k, the moveable platform 12a is independently lifted by the mechanism (e.g., air cylinder 18b) to a height where the bottom of the moveable platform 12a is above a top plane of the workpiece, W.

In FIG. 2l, the workpiece chuck 14 is moved under the moveable platform 12a to a point where the moveable platform 12a can now be in the original position of the moveable platform 12b (e.g., to the left of the workpiece chuck 14). In FIG. 2m, the moveable platform 12a is lowered to a height which would be planar with the workpiece, W, e.g., original height. In FIG. 2n, the workpiece chuck 14 and the moveable platform 12a are moved under the lifted solder injection head 20 and the moveable platform 12b until the moveable platform is aligned with the lifting mechanism 18a. This movement in the x direction is provided by the carriage. In this way, the moveable platform 12b (with the solder injection head) is now positioned in the original position of the moveable platform 12a, e.g., to the right of the workpiece chuck 14.

In FIG. 2o, the solder injection head 20 and the moveable platform 12b are lowered into the original position of the moveable platform 12a, e.g., to the right of the workpiece chuck 14. The moveable platforms 12a, 12b are now swapped and ready for a next workpiece. In FIG. 2p, the workpiece W is removed. In embodiments, the operational stages of FIGS. 2a-2p can be repeated.

The methods as described above are used in the fabrication of integrated circuit chips. The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

While the invention has been described in terms of embodiments, those of skill in the art will recognize that the invention can be practiced with modifications and in the spirit and scope of the appended claims.

What is claimed is:

1. A tool, comprising:
a first moveable platform positioned on a first side of a workpiece chuck;
a second moveable platform positioned on a second side of the workpiece chuck; and
a solder injection head having a seal configured to seal molten solder within the solder injection head when contacting a surface of the first moveable platform or the second moveable platform.

2. The tool of claim 1, wherein the first moveable platform and the second moveable platform are configured to be moveable in a horizontal direction, independent of the solder injection head.

3. The tool of claim 1, wherein the first moveable platform is configured to be moveable in a vertical direction and remain stationary in a horizontal position and the second moveable platform is independently moveable in the horizontal direction.

4. The tool of claim 1, further comprising a plurality of horizontally stationary lifting mechanisms configured to independently lift the first moveable platform and the second moveable platform.

5. The tool of claim 4, wherein the plurality of horizontally stationary lifting mechanisms lift at least one of the first moveable platform and the second moveable platform when in alignment therewith.

6. The tool of claim 1, wherein the first moveable platform is configured to be in a raised position while the second moveable platform is configured to be in a lowered position while moving in a horizontal direction.

7. The tool of claim 6, wherein the workpiece chuck is moveable in the horizontal direction with the second moveable platform when the first moveable platform is in a raised position with the solder injection head thereon.

8. The tool of claim 1, wherein the solder injection head is stationary with respect to a horizontal movement of the first moveable platform, the second moveable platform and the workpiece chuck.

9. The tool of claim 1, further comprising a moveable carriage with is mounted to the first moveable platform, the second moveable platform and the workpiece chuck.

10. The tool of claim 1, further comprising mechanisms configured to move the first moveable platform and the second moveable platform away from and toward the workpiece chuck in a horizontal direction.

11. The tool of claim 1, further comprising a pressure device configured to apply a pressure against the solder injection head thereby preventing leakage between the seal and the first moveable platform and the second moveable platform.

12. The tool of claim 1, wherein the solder injection head is moveable in a vertical direction when on either of the first moveable platform or the second moveable platform.

13. A tool, comprising:
a workpiece chuck moveable in a horizontal direction and stationary in a vertical direction;
a first moveable platform positioned on a first side of a workpiece chuck and independently moveable in the horizontal direction and the vertical direction;
a second moveable platform positioned on a second side of the workpiece chuck and independently moveable in the horizontal direction and the vertical direction; and
a solder injection head having a seal configured to seal molten solder within the solder injection head when contacting a surface of either the first moveable platform or the second moveable platform, the solder injection head configured to move in the vertical direction when positioned on one of the first moveable platform and the second moveable platform and remain stationary in the horizontal direction.

14. The tool of claim 13, further comprising a carriage to move the workpiece chuck, the first moveable platform and the second moveable platform in the horizontal direction.

15. The tool of claim 13, further comprising a plurality of lifting mechanisms which remain stationary in the horizontal direction and lift the first moveable platform and the second moveable platform in the vertical direction when aligned therewith.

16. A method of injecting solder into molds comprising moving a workpiece chuck and a starting platform initially in a starting position to a finishing position and a finishing platform to the starting position.

17. The method of claim 16, wherein the finishing platform and the starting platform are independently moved in a horizontal direction towards the workpiece chuck prior to injecting solder into a mold and moved away from the workpiece chuck after injecting solder into the mold.

18. The method of claim 16, further comprising lifting the finishing platform in a vertical direction when a solder injection head is placed thereon and lifting the starting platform in the vertical direction while the workpiece chuck is moved in a horizontal position away from the finishing platform and the starting platform.

19. The method of claim 18, further comprising lowering the starting platform and moving the starting platform and the workpiece chuck in a direction past the finishing platform.

20. The method of claim 19, further comprising lowering the finishing platform into the starting position after the starting platform and the workpiece chuck pass the finishing platform.
